(19) United States
(12) Patent Application Publication
(10) Pub. No.: US 2013/0196129 A1
(43) Pub. Date: Aug. 1, 2013

(54) ANISOTROPIC CONDUCTIVE FILM AND APPARATUS INCLUDING THE SAME

(71) Applicants: Woo Suk LEE, Uiwang-si (KR); Bong Yong KIM, Uiwang-si (KR); Dong Seon UH, Uiwang-si (KR); Jin Seong PARK, Uiwang-si (KR); Kyoung Soo PARK, Uiwang-si (KR); Woo Jun LIM, Uiwang-si (KR); Kyung Jin LEE, Uiwang-si (KR)

(72) Inventors: Woo Suk LEE, Uiwang-si (KR); Bong Yong KIM, Uiwang-si (KR); Dong Seon UH, Uiwang-si (KR); Jin Seong PARK, Uiwang-si (KR); Kyoung Soo PARK, Uiwang-si (KR); Woo Jun LIM, Uiwang-si (KR); Kyung Jin LEE, Uiwang-si (KR)

(21) Appl. No.: 13/803,266

(22) Filed: Mar. 14, 2013

Related U.S. Application Data
(63) Continuation of application No. PCT/KR2011/008806, filed on Nov. 17, 2011.

(30) Foreign Application Priority Data
Dec. 23, 2010 (KR) 10-2010-0133985

(51) Int. Cl. H01R 4/04

(52) U.S. Cl. CPC H01R 4/04
USPC 428/212

(57) ABSTRACT

An anisotropic conductive film includes a first insulating adhesive layer, a conductive adhesive layer, and a second insulating adhesive layer which are sequentially stacked on a base film, wherein an adhesive strength ratio of the second insulating adhesive layer to the first insulating adhesive layer is about 1.1 to about 20.

### CROSS-REFERENCE TO RELATED APPLICATION

This application is a continuation of pending International Application No. PCT/KR2011/008806, entitled “ANISOTROPIC CONDUCTIVE FILM AND APPARATUS INCLUDING THE SAME,” which was filed on Nov. 17, 2011, the entire contents of which are hereby incorporated by reference.

This application also claims priority under 35 U.S.C. §119 to Korean Patent Application No. 10-2010-0133985 filed on Dec. 23, 2010, in the Korean Intellectual Property Office, and entitled: “ANISOTROPIC CONDUCTIVE FILM AND APPARATUS INCLUDING THE SAME,” the entire contents of which is hereby incorporated by reference.

### BACKGROUND

1. Field

Embodiments relate to an anisotropic conductive film and an apparatus including the same.

2. Description of the Related Art

The term “anisotropic conductive films” refers to film-like adhesives in which conductive particles such as metal particles or metal-coated plastic particles are dispersed. Anisotropic conductive films are widely used in various applications, such as module circuit connection in the field of flat panel displays and component mounting in the field of semiconductors. When an anisotropic conductive film is interposed between circuit boards to be connected, followed by hot pressing under particular conditions, circuit terminals of the circuit boards are electrically connected to each other through conductive particles, and spaces between adjacent circuit terminals are filled with an insulating adhesive resin to make the conductive particles independent of each other, thereby achieving insulation performance between the circuit terminals.

### SUMMARY

Embodiments are directed to an anisotropic conductive film including a first insulating adhesive layer, a conductive adhesive layer, and a second insulating adhesive layer which are sequentially stacked on a base film, wherein an adhesive strength ratio of the second insulating adhesive layer to the first insulating adhesive layer is about 1.1 to about 20.

The adhesive strength ratio of the second insulating adhesive layer to the first insulating adhesive layer may be about 1.3 to about 5.

The first insulating adhesive layer may have an adhesive strength of about 10 to about 100 gf, and the second insulating adhesive layer may have an adhesive strength of about 50 to about 150 gf.

The first insulating adhesive layer may have an adhesive strength of about 20 to about 60 gf, and the second insulating adhesive layer has an adhesive strength of about 50 to about 90 gf.

A melt viscosity ratio of the second insulating adhesive layer to the first insulating adhesive layer at 40° C. may be about 0.01 to about 1.0.

The first insulating adhesive layer may have a melt viscosity of about 1.0×10⁵ to about 5.0×10⁵ Pa·s, and the second insulating adhesive layer has a melt viscosity of about 1.0×10⁴ to about 1.5×10⁵ Pa·s.

A thickness ratio of the first insulating adhesive layer to the conductive adhesive layer may be about 1.1 to about 7.5, and a thickness ratio of the conductive adhesive layer to the second insulating adhesive layer is about 1.3 to about 150.

The first insulating adhesive layer may include a binder part, a curing part, and a radical initiator. The binder part may include a polyurethane acrylate resin. The curing part may include an epoxy (meth)acrylate oligomer and a (meth)acrylate monomer.

The first insulating adhesive layer may include about 55 to about 80 wt % of the binder part, about 9 to about 40 wt % of the curing part, and about 1 to about 5 wt % of the radical initiator, based on solid content.

The conductive adhesive layer may include a binder part, a curing part, a radical initiator, and conductive particles. The binder part may include an acrylonitrile thermoplastic resin, a polyurethane acrylate resin and a phenoxy thermoplastic resin. The curing part may include an epoxy (meth)acrylate oligomer and a (meth)acrylate monomer.

The conductive adhesive layer may include about 35 to about 68 wt % of the binder part, about 30 to about 50 wt % of the curing part, about 1 to about 5 wt % of the radical initiator, and about 1 to about 10 wt % of the conductive particles, based on solid content.

The second insulating adhesive layer may include a binder part, a curing part, and a radical initiator. The binder part may include a polyurethane acrylate resin. The curing part may include an epoxy (meth)acrylate oligomer and a (meth)acrylate monomer.

The second insulating adhesive layer may include about 55 to about 80 wt % of the binder part, about 9 to about 40 wt % of the curing part, and about 1 to about 5 wt % of the radical initiator, based on solid content.

Embodiments are also directed to an apparatus including the anisotropic conductive film.

### BRIEF DESCRIPTION OF DRAWINGS

Features will become apparent to those of skill in the art by describing in detail exemplary embodiments with reference to the attached drawings in which:

FIG. 1 illustrates a sectional view of an anisotropic conductive film according to an exemplary embodiment.

FIG. 2 illustrates a method for measuring an adhesive strength of an insulating adhesive layer of an anisotropic conductive film.

FIG. 3 illustrates images corresponding to a standard for evaluating preliminary tack of an anisotropic conductive film.

FIG. 4 illustrates a sectional view of an apparatus according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In accordance with an embodiment, an anisotropic conductive film includes a first insulating adhesive layer, a conductive adhesive layer, and a second insulating adhesive layer which are sequentially deposited on a base film, wherein an adhesive strength ratio of the second insulating adhesive layer to the first insulating adhesive layer is about 1.1 to about 20.

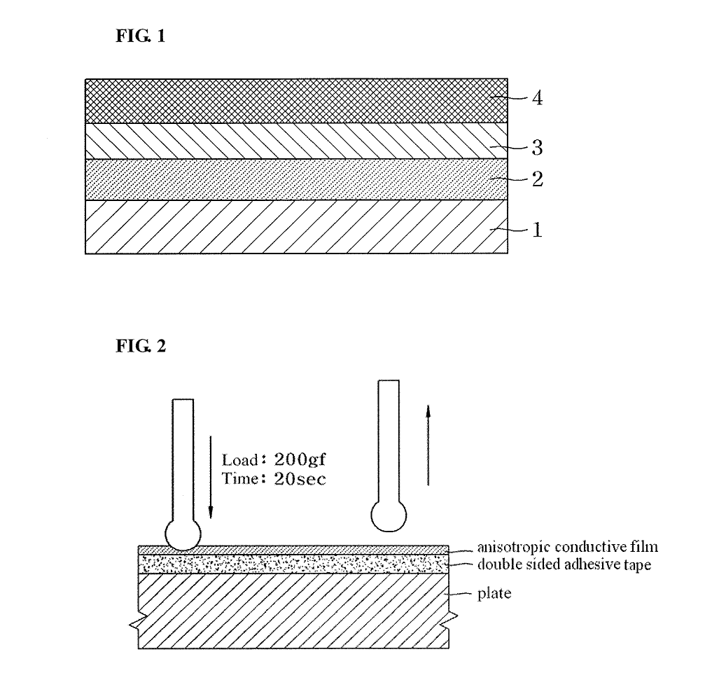

Regarding FIG. 1, an anisotropic conductive film may include a first insulating adhesive layer 2, a conductive adhesive layer 3, and a second insulating adhesive layer 4 which are sequentially deposited on a base film 1.

If the adhesive strength ratio is more than 1.1, when the base film is removed after preliminarily pressing the anisotropic conductive film to a circuit connection member, the anisotropic conductive film remains attached to the circuit connection member, thereby indicating that there is sufficient preliminary tack. If the adhesive strength ratio is less than 20, it is possible to remove the anisotropic conductive film from the circuit connection member when reworking preliminary pressing. For example, the adhesive strength ratio may be about 1.3 to 5.

In the anisotropic conductive film, the first insulating adhesive layer may have an adhesive strength of about 10 to about 100 gf, and the second insulating adhesive layer may have an adhesive strength of about 50 to about 150 gf. For example, the first insulating adhesive layer may have an adhesive strength of about 20 to about 60 gf, and the second insulating adhesive layer may have an adhesive strength of about 50 to about 90 gf.

In the anisotropic conductive film, a melt viscosity ratio of the second insulating adhesive layer to the first insulating adhesive layer at 40° C. may be about 0.01 to about 1.0. Within this range, the second insulating adhesive layer may be properly attached to the circuit connection member in preliminary pressing, and the base film may be smoothly separated from the first insulating adhesive layer. For example, in the anisotropic conductive film, the first insulating adhesive layer may have a melt viscosity of about 1.0×10⁵ to about 5.0×10⁵ Pa·s at 40° C., and the second insulating adhesive layer may have a melt viscosity of about 1.0×10⁴ to about 1.5×10⁵ Pa·s at 40° C. (Pa·s=Pascal seconds). The melt viscosity is measured at 40° C. under conditions that temperature is elevated at 10° C. /min, strain is 5%, and frequency is 1 rad/s using a parallel plate and a disposable aluminum plate (Diameter: 8 mm, ARES G2, TA Instruments).

The conductive adhesive layer of the anisotropic conductive film may have a remarkably higher melt viscosity at 40° C. than the first and second insulating adhesive layers, so that the conductive adhesive layer may have a good preliminary tack.

In the anisotropic conductive film, a thickness ratio of the first insulating adhesive layer to the conductive adhesive layer (that is, a ratio obtained by dividing the thickness of the first adhesive layer by the thickness of the conductive adhesive layer) may be about 1.1 to about 7.5, and a thickness ratio of the conductive adhesive layer to the second insulating adhesive layer (that is, a ratio obtained by dividing the thickness of the conductive adhesive layer by the thickness of the second adhesive layer) may be about 1.3 to about 150. For example, the first insulating adhesive layer may have a thickness of about 5 to about 20 μm, the conductive adhesive layer may have a thickness of about 3 to about 15 μm, and the second insulating adhesive layer may have a thickness of about 0.1 to about 10 μm.

Next, components of the constituent layers of the anisotropic conductive film will be described in detail. Each of the first and second insulating adhesive layers includes a binder part, a curing part and a radical initiator. The conductive adhesive layer includes a binder part, a curing part, a radical initiator, and conductive particles.

(A) Binder Part

Thermoplastic Resin

The binder part is used in forming the first and second insulating adhesive layers and the conductive adhesive layer. The binder part may serve as a matrix for formation of the layers. The binder part may include a thermoplastic resin. The thermoplastic resin may include at least one selected from the group of acrylonitrile, phenoxy, butadiene, acrylic, urethane, polyamide, olefin, silicone, and nitrile butadiene rubber (NBR) resins, as examples. For example, acrylonitrile butadiene resins may be used.

The thermoplastic resin may have a weight average molecular weight of about 1,000 to about 1,000,000 g/mol. Within this range, appropriate film strength may be obtained, and phase separation may be reduced or prevented without reducing adhesion to an adherend. Deterioration of adhesive strength may be reduced or prevented.

Polyurethane Acrylate Resin

An available polyurethane acrylate resin may be prepared by copolymerization of an isocyanate, a polyol, a diol, and a hydroxyl acrylate.

Herein, the terms “acrylate” and “(meth)acrylate” may be used interchangeably to refer to either acrylate or methacrylate.

The isocyanate may be at least one selected from the group of aromatic, aliphatic, and alicyclic diisocyanates. Examples of such isocyanates include at least one selected from the group of toluene diisocyanate, tetramethylene-1,4-diisocyanate, hexamethylene-1,6-diisocyanate, cyclohexylene-1,4-diisocyanate, methylene bis(4-cyclohexyl isocyanate), isophorone diisocyanate, and 4,4-methylene bis(cyclohexyl diisocyanate). These isocyanates may be used alone or as a mixture of two or more thereof.

The polyol may be at least one selected from the group of polyester polyols, polyether polyols, and polycarbonate polyols. The polyol may be obtained by condensation of a dicarboxylic acid compound and a diol compound. Examples of such dicarboxylic acids include, for example, succinic acid, glutaric acid, isophthalic acid, adipic acid, suberic acid, azelaic acid, sebacic acid, dodecanedicarboxylic acid, hexahydrophthalic acid, isophthalic acid, terephthalic acid, ortho-phthalic acid, tetrachlorophthalic acid, 1,5-naphthalenedicarboxylic acid, fumaric acid, maleic acid, itaconic acid, citraconic acid, methaconic acid, and tetrahydrophthalic acid. Examples of such diol compounds include, for example, ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, dibutylene glycol, 2-methyl-1,3-pentanediol, 2,2,4-trimethyl-1,3-pentanediol, and 1,4-cyclohexanedimethanol. Examples of suitable polyether polyols include, for example, polyethylene glycol, polypropylene glycol, polytetramethylene glycol, and polytetraethylene glycol.

The diol may be at least one selected from the group of 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, and 1,4-cyclohexanedimethanol, as examples.

A hydroxyl acrylate may be used in forming the polyurethane acrylate resin. Examples of the hydroxyl acrylate include C1 to C20 acrylates having a hydroxyl group.

A molar ratio of isocyanate groups (NCO) to hydroxyl groups (OH) may be about 1.04 to about 1.6 among the three components other than the hydroxyl acrylate. The three components may have a polyol content of about 70% or less. The polyurethane acrylate resin may be prepared by reacting the hydroxyl acrylate with the terminal diisocyanate groups of the synthesized polyurethane at a molar ratio of about 0.1 to about 2.1 and adding an alcohol to terminate the reaction of the residual isocyanate groups.

The polyurethane acrylate resin may be prepared by any suitable polymerization method. For example, polyaddition may be used. In the polymerization, a catalyst, such as dibutyltin dilaurate, may be used. The polymerization may be carried out at about 80 to about 100 ° C. for about 4 to about 6 hours.

(B) Curing Part

The curing part serves to secure adhesive strength and connection reliability between connected layers. The curing part may include at least one radical curable unit selected from (meth)acrylate oligomers and (meth)acrylate monomers.

(Meth)acrylate Oligomer

Examples of (meth)acrylate oligomers may include, for example, epoxy (meth)acrylate oligomers having an intermediate molecular structure with a skeleton selected from 2-bromohydroquinone, resorcinol, catechol, bisphenols such as bisphenol A, bisphenol F, bisphenol AD and bisphenol S, 4,4′-dihydroxybiphenyl, and bis(4-hydroxyphenyl)ether, and (meth)acrylate oligomers having alkyl, aryl, methylol, allyl, alicyclic, halogen (tetrabromobisphenol A), or nitro groups.

(Meth)acrylate Monomer

The (meth)acrylate monomer may be at least one selected from the group of 6-hexanediol mono(meth)acrylate, 2-hydroxyethyl (meth)acrylate, 2-hydroxypropyl (meth)acrylate, 2-hydroxybutyl (meth)acrylate, 2-hydroxy-3-phenyloxypropyl (meth)acrylate, 1,4-butanediol (meth)acrylate, 2-hydroxyalkyl (meth)acryloyl phosphate, 4-hydroxycyclohexyl (meth)acrylate, neopentyl glycol mono(meth)acrylate, trimethylolethane di(meth)acrylate, trimethylolpropane di(meth)acrylate, pentaerythritol tri(meth)acrylate, dipentaerythritol penta(meth)acrylate, pentaerythritol hexa(meth)acrylate, dipentaerythritol hexa(meth)acrylate, glycerin di(meth)acrylate, t-hydrofurfuryl (meth)acrylate, isodecyl (meth)acrylate, 2-(2-ethoxyethoxy)ethyl (meth)acrylate, stearyl (meth)acrylate, lauryl (meth)acrylate, 2-phenoxyethyl (meth)acrylate, isobornyl (meth)acrylate, tridecyl (meth)acrylate, ethoxylated nonylphenol (meth)acrylate, ethylene glycol di(meth)acrylate, diethylene glycol di(meth)acrylate, triethylene glycol di(meth)acrylate, t-ethylene glycol di(meth)acrylate, polyethylene glycol di(meth)acrylate, 1,3-butylene glycol di(meth)acrylate, tripropylene glycol di(meth)acrylate, ethoxylated bisphenol-A di(meth)acrylate, cyclohexanedimethanol di(meth)acrylate, phenoxy-t-glycol (meth)acrylate, 2-methacryloyloxyethyl phosphate, dimethyloltricyclodecane di(meth)acrylate, trimethylolpropane benzoate acrylate, acid phosphoxyethyl (meth)acrylate, 2-acryloyloxyethyl phthalate, and combinations thereof, as examples.

(C) Radical Initiator

The radical initiator may include a photopolymerization initiator, a heat-curing initiator, or combinations thereof.

Examples of photopolymerization initiators include benzophenone, methyl o-benzoylbenzoate, 4-benzoyl-4-methyldiphenyl sulfide, isopropylthioxanthone, diethylthioxanthone, ethyl 4-diethylbenzoate, benzoin ether, benzoin propyl ether, 2-hydroxy-2-methyl-1-phenylpropan-1-one, and diethoxyacetophenone.

Examples of heat-curing initiators include peroxide and azo initiators. As the peroxide initiators, benzoyl peroxide, lauryl peroxide, t-butyl peroxylaurate, and 1,1,3,3-4-methylbutylperoxy-2-ethylhexanoate may be used.

(D) Conductive Particles

The conductive particles may be used as fillers to impart conductive performance to the conductive adhesive layer of the anisotropic conductive film.

Examples of the conductive particles may include metal particles including gold, silver, nickel, copper, tin, or solder, carbon particles, metal-coated resin particles, such as particles of benzoguanamine, polymethylmethacrylate (PMMA), an acrylic copolymer, polystyrene or a modified resin thereof coated with gold, silver, nickel, copper, tin, or solder metal, or conductive particles coated with insulating particles or an insulating film.

The conductive particles may have an average particle diameter (D50) of about 0.1 to about 10 μm.

The first insulating adhesive layer may include the binder part, the curing part, and the radical initiator. The binder part may include at least one of the polyurethane acrylate resins, and the curing part may include a (meth)acrylate oligomer including an epoxy (meth)acrylate, and a (meth)acrylate monomer. The first insulating adhesive layer may include about 55 to about 80% by weight (wt %) of the binder part, about 9 to about 40 wt % of the curing part, and about 1 to about 5 wt % of the radical initiator, based on solid content. Within this range, the first insulating adhesive layer may have a proper melt viscosity and adhesion. For example, the first insulating adhesive layer may include about 60 to about 75 wt % of the binder part, about 24 to about 36 wt % of the curing part, and about 1 to about 4 wt % of the radical initiator. The polyurethane acrylate resin used for the binder part may be obtained by polymerization of a polyol, a hydroxyl acrylate, a diol, and an isocyanate. Polyurethane acrylate resins having a molar ratio of hydroxyl acrylate/isocyanate of about 0.4 to about 0.9 and/or having a molar ratio of about 1.0 to about 1.2 may be used.

The conductive adhesive layer may include the binder part, the curing part, the radical initiator, and the conductive particles. The binder part may include at least one of a thermoplastic resin including acrylonitrile, a polyurethane acrylate resin, and a phenoxy resin. The curing part may include a (meth)acrylate oligomer including an epoxy (meth)acrylate, and a (meth)acrylate monomer. The conductive adhesive layer may include about 35 to about 68 wt % of the binder part, about 30 to about 50 wt % of the curing part, about 1 to about 5 wt % of the radical initiator, and about 1 to about 10 wt % of the conductive particles based on solid content. Within this range, proper adhesive strength and contact resistance reliability may be exhibited. For example, the conductive adhesive layer may include about 40 to about 60 wt % of the binder part, about 35 to about 45 wt % of the curing part, about 2 to about 5 wt % of the radical initiator, and about 3 to about 10 wt % of the conductive particles. In this case, the binder part may include about 10 to about 40 wt % of the acrylonitrile thermoplastic resin, about 40 to about 70 wt % of the polyurethane acrylate resin, and about 10 to about 35 wt % of the phenoxy thermoplastic resin based on solid content.

The second insulating adhesive layer may include the binder part, the curing part, and the radical initiator. The binder part may include at least one of the polyurethane acrylate resins, and the curing part may include a (meth)acrylate oligomer including an epoxy (meth)acrylate, and a (meth)acrylate monomer. The second insulating adhesive layer may include about 55 to about 80 wt % of the binder part, about 9 to about 40 wt % of the curing part, and about 1 to about 5 wt % of the radical initiator based on solid content. Within this range, the second insulating adhesive layer may have a proper melt viscosity and adhesion. For example, the second insulating adhesive layer may include about 60 to about 75 wt % of the binder part, about 24 to about 36 wt % of the curing part, and about 1 to about 4 wt % of the radical initiator. The polyurethane acrylate resin used for the binder part may be obtained by polymerization of a polyol, a hydroxyl acrylate, and an isocyanate. Polyurethane acrylate resins having a molar ratio of hydroxyl acrylate/isocyanate of about 0.4 to about 0.9 and/or having a molar ratio of about 1.0 to about 1.2 may be used.

The base film of the anisotropic conductive film may include a polyolefin film selected from polyethylene, polypropylene, ethylene/propylene copolymers, polybutene-1, ethylene/vinyl acetate copolymers, polyethylene/styrene butadiene rubber mixtures, and polyvinyl chloride, as examples. Further, polymers such as polyethylene terephthalate, polycarbonate, and poly(methyl methacrylate), thermoplastic elastomers, such as polyurethane and polyamide-polyol copolymers, or mixtures thereof, may be used.

The thickness of the base film can be selected in an appropriate range, for example, from about 20 to about 80 μm.

The anisotropic conductive film may connect a first circuit terminal to a second circuit terminal as follows: preliminary pressing of the anisotropic conductive film is conducted such that the second insulating adhesive layer contacts a first circuit terminal, e.g., a printed circuit board (PCB) terminal. The base film is removed, and heating and pressing are carried out such that the first insulating adhesive layer is in contact with the second circuit terminal, e.g., a chip-on-film (COF) terminal.

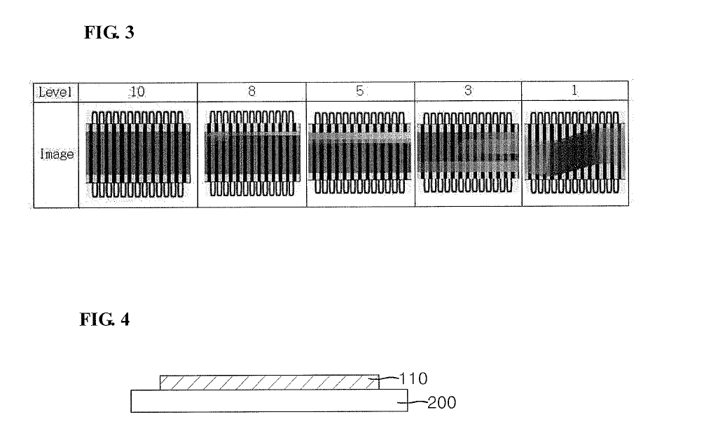

According to another embodiment, an apparatus including the anisotropic conductive film is provided. The apparatus may include one or more of various types of display apparatuses and semiconductor devices that employ the anisotropic conductive film for connection of modules, such as, for example, an LCD. As illustrated in FIG. 4, the apparatus may include a substrate 200 including electrodes, and an anisotropic conductive film 110 including the first insulating adhesive layer, the conductive adhesive layer, and the second insulating adhesive layer which are sequentially stacked, and formed on the substrate 200.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further it is to be understood that the embodiments are not limited to the particular details described in the Examples and Comparative Examples.

### Examples

### Preparative Example 1

### Preparation of Polyurethane Acrylate Resin 1

60 wt % of a polyol (polytetramethylene glycol), 39.97 wt % of a mixture including 1,4-butanediol, toluene diisocyanate, and hydroxyethyl methacrylate, and 0.03 wt % of dibutyltin dilaurate as a catalyst were used. First, the polyol, 1,4-butanediol, and toluene diisocyanate were reacted to synthesize a prepolymer having an isocyanate terminal. Then, the prepolymer having the isocyanate terminal was reacted with hydroxyethyl methacrylate to prepare a polyurethane acrylate resin. Here, a molar ratio of hydroxyethyl methacrylate/isocyanate of the prepolymer was 0.5. The prepared polyurethane acrylate resin 1 had a weight average molecular weight of 27,000 g/mol.

### Preparative Example 2

### Preparation of Polyurethane Acrylate Resin 2

60 wt % of a polyol (polytetramethylene glycol), 39.97 wt % of a mixture including 1,4-butanediol, toluene diisocyanate, and hydroxyethyl methacrylate, and 0.03 wt % of dibutyltin dilaurate as a catalyst were used. First, the polyol, 1,4-butanediol, and toluene diisocyanate were reacted to synthesize a prepolymer having an isocyanate terminal. Then, the prepolymer having the isocyanate terminal was reacted with hydroxyethyl methacrylate to prepare a polyurethane acrylate resin. Here, a molar ratio of hydroxyethyl methacrylate/isocyanate of the prepolymer was 1. The prepared polyurethane acrylate resin 2 had a weight average molecular weight of 28,000 g/mol.

Details of components used in Examples 1 and 2 and Comparative Examples 1 and 2 are as follows:

1. Binder Part
Acrylonitrile butadiene resin: Nipol 1072 (Nippon Zeon Corp.)
Polyurethane acrylate resin: As prepared in Preparative Examples 1 and 2
Phenoxy resin: E4275 (Japan Epoxy Resins Co., Ltd.)

2. Curing Part
Epoxy (meth)acrylate oligomer: SP1509 (Showa Highpolymer)
2-Methacryloyloxyethyl phosphate
Pentaerythritol tri(meth)acrylate
2-Hydroxyethyl (meth)acrylate

3. Radical Initiator
Benzoyl peroxide and lauryl peroxide

4. Conductive Particles

Nickel particles having an average particle diameter (D50) of 4.5 μm

### Example 1

### Preparation of Anisotropic Conductive Film

(1) Preparation of First Insulating Adhesive Layer (N1)

25 wt % of the polyurethane acrylate resin 1, 43 wt % of the polyurethane acrylate resin 2, 20 wt % of an epoxy (meth)acrylate oligomer, 2 w % of 2-methacryloyloxyethyl phosphate, 5 wt % of pentaerythritol tri(meth)acrylate, 3 wt % of 2-hydroxyethyl (meth)acrylate, and 2 wt % of benzoyl peroxide were mixed to prepare a first insulating adhesive layer composition. The composition was deposited on a polyethylene terephthalate (PET) release film and dried using hot air at 70° C. for 5 minutes, thereby preparing a first insulating adhesive layer having a thickness of 19 μm and an adhesive strength of 22 gf.

(2) Preparation of Conductive Adhesive Layer (A)

25 wt % of an acrylonitrile butadiene resin, 10 wt % of the polyurethane acrylate resin 1, 15 wt % of a phenoxy resin, 30 wt % of an epoxy (meth)acrylate oligomer, 2 w % of 2-methacryloyloxyethyl phosphate, 8 wt % of pentaerythritol tri(meth)acrylate, 2 wt % of lauryl peroxide, and 8 wt % of nickel particles were mixed to prepare a conductive adhesive layer composition. The composition was deposited on a PET release film and dried using hot air at 70° C. for 5 minutes, thereby preparing a conductive adhesive layer having a thickness of 10 μm.

(3) Preparation of Second Insulating Adhesive Layer (N2)

30 wt % of the polyurethane acrylate resin 1, 33 wt % of the polyurethane acrylate resin 2, 20 wt % of an epoxy (meth)acrylate polymer, 2 w% of 2-methacryloyloxyethyl phosphate, 5 wt % of pentaerythritol tri(meth)acrylate, 8 wt % of 2-hydroxyethyl (meth)acrylate, and 2 wt % of benzoyl peroxide were mixed to prepare a second insulating adhesive layer composition. The composition was deposited on a PET release film and dried using hot air at 70° C. for 5 minutes, thereby preparing a second insulating adhesive layer having a thickness of 6 μm and an adhesive strength of 54 gf.

(4) Preparation of Anisotropic Conductive Film

The first insulating adhesive layer (N1), the conductive adhesive layer (A), and the second insulating adhesive layer (N2) were stacked sequentially on a PET base film, thereby preparing an anisotropic conductive film.

### Example 2

### Preparation of Anisotropic Conductive Film

An anisotropic conductive film was prepared by the same manner as in Example 1 except that the components were used according to a composition listed in Table 1.

### Comparative Examples 1 and 2

### Preparation of Anisotropic Conductive Film

An anisotropic conductive film was prepared by the same manner as in Example 1 except that the components were used according to a composition listed in Table 2.

TABLE 1
(Unit: wt %)

| | | Example 1 | | | Example 2 | | |
|---|---|---|---|---|---|---|---|
| | | N1 | A | N2 | N1 | A | N2 |
| Binder part | Acrylonitrile butadiene | — | 25 | — | — | 25 | — |
| | Polyurethane acrylate | 25 | 10 | 30 | 30 | 10 | 35 |
| | resin 1 | | | | | | |
| | Polyurethane acrylate | 43 | — | 33 | 33 | — | 28 |
| | resin 2 | | | | | | |
| | Phenoxy resin | — | 15 | — | — | 15 | |
| Curing part | Epoxy (meth)acrylate | 20 | 30 | 20 | 20 | 30 | 20 |
| | oligomer | | | | | | |
| | 2-Methacryloyloxyethyl | 2 | 2 | 2 | 2 | 2 | 2 |
| | phosphate | | | | | | |
| | Pentaerythritol | 5 | 8 | 5 | 5 | 8 | 5 |
| | tri(meth)acrylate | | | | | | |
| | 2-Hydroxyethyl | 3 | — | 8 | 8 | — | 8 |
| | (meth)acrylate | | | | | | |
| Radical | Benzoyl peroxide | 2 | — | 2 | 2 | — | 2 |
| initiator | Lauryl peroxide | — | 2 | — | — | 2 | — |
| Conductive | Nickel particles | — | 8 | — | — | 8 | — |
| particles | | | | | | | |

| | | | | | | |
|---|---|---|---|---|---|---|
| Thickness (μm) | 19 | 10 | 6 | 19 | 10 | 6 |
| Adhesive strength (gf) | 22 | — | 54 | 56 | — | 82 |

TABLE 2
(Unit: wt %)

| | | Comparative | | | Comparative | | |
|---|---|---|---|---|---|---|---|
| | | Example 1 | | | Example 2 | | |
| | | N1 | A | N2 | N1 | A | N2 |
| Binder part | Acrylonitrile butadiene | — | 25 | — | — | 25 | — |
| | Polyurethane acrylate | 30 | 10 | 25 | 35 | 10 | 30 |
| | resin 1 | | | | | | |
| | Polyurethane acrylate | 33 | — | 43 | 28 | — | 33 |
| | resin 2 | | | | | | |
| | Phenoxy resin | — | 15 | — | — | 15 | — |
| Curing part | Epoxy (meth)acrylate | 20 | 30 | 20 | 20 | 30 | 20 |
| | oligomer | | | | | | |
| | 2-Methacryloyloxyethyl | 2 | 2 | 2 | 2 | 2 | 2 |
| | phosphate | | | | | | |
| | Pentaerythritol | 5 | 8 | 5 | 5 | 8 | 5 |
| | tri(meth)acrylate | | | | | | |
| | 2-Hydroxyethyl | 8 | — | 3 | 8 | — | 8 |
| | (meth)acrylate | | | | | | |
| Radical | Benzoyl peroxide | 2 | — | 2 | 2 | — | 2 |
| initiator | Lauryl peroxide | — | 2 | — | — | 2 | — |
| Conductive | Nickel particles | — | 8 | — | — | 8 | — |
| particles | | | | | | | |

| | | | | | | |
|---|---|---|---|---|---|---|
| Thickness (μm) | 19 | 10 | 6 | 19 | 10 | 6 |
| Adhesive strength (gf) | 56 | — | 20 | 88 | — | 54 |

The adhesive strength of the insulating adhesive layers of Examples and Comparative Examples was measured using a probe tack tester (TopTack 2000A, ChemiLAB), as shown in FIG. 2.

To measure the adhesive strength of the first insulating layer, the anisotropic conductive film was attached to upper side of a double sided adhesive tape attached to upper side of a 30° C. plate, by facing the second insulating layer with the upper side of the double sided adhesive tape, thus to expose the first insulating layer of the anisotropic adhesive film. A 200 gf load was applied to the first insulating layer of the anisotropic conductive film for 20 seconds pressing a stainless steel probe having a spherical shape with a diameter of ⅜ inch. While separating the probe from the first insulating layer at a rate of 0.08 mm/sec, a maximum load at which the probe was separated from the first adhesive layer was measured.

To measure the adhesive strength of the second insulating layer, the anisotropic conductive film was attached to upper side of a double sided adhesive tape attached to upper side of a 30° C. plate, by facing the first insulating layer with the upper side of the double sided adhesive tape, thus to expose the second layer of the anisotropic adhesive film. A 200 gf load was applied to the second insulating layer of the anisotropic conductive film for 20 seconds pressing a stainless steel probe having a spherical shape with a diameter of ⅜ inch. While separating the probe from the second insulating layer at a rate of 0.08 mm/sec, a maximum load at which the probe was separated from the second adhesive layer was measured.

The adhesive strength was measured 7 times at different spots of each specimen, and mean adhesive strength was calculated using the measured values except for the maximum value and the minimum value.

### Experimental Example

### Evaluation of Physical Properties of Anisotropic Conductive Films

The physical properties of the anisotropic conductive films produced in Examples 1 and 2 and Comparative Examples 1 and 2 were evaluated by the following methods, and the results are shown in Table 3.

<Methods of Evaluation of Physical Properties>

1. Contact Resistance and Reliability

A 200 μm-pitch PCB (Terminal width: 100 μm, Distance between terminals: 100 μm, Material: FR-4) and a COF (Terminal width: 100 μm, Distance between terminals: 100 μm) were used. After each of the anisotropic conductive films of the Examples and Comparative Examples was preliminarily pressed to the PCB circuit terminal at 60° C. and 1 MPa for 1 second, the release film was removed, and then the film was finally pressed to the COF circuit terminal at 180° C. and 3 MPa for 5 seconds. Then, contact resistance was measured. Further, reliability of contact resistance was measured after the film was left at 85° C. and RH 85% for 500 hours.

2. Preliminary Tack

Each of the anisotropic conductive films of Examples and Comparative Examples was preliminarily pressed to a PCB for a 23-inch monitor (Total PCB length: 50 cm, Circuit terminal pitch: 300 μm) at 60° C. and 1 MPa for 1 second, and then the release film was removed. Then, the state of the anisotropic conductive film attached to the PCB circuit terminal was observed and evaluated based on the following standard. FIG. 3 illustrates images showing an evaluation standard for evaluating preliminary tack state of an anisotropic conductive film attached to the PCB circuit terminal.

<Standard>

Level 10: Entirely attached

Level 8: Partly and discontinuously separated

Level 5: Partly and continuously separated

Level 3: Partly and continuously separated in at least two spots

Level 1: Entirely not attached

TABLE 3

| | | | | Comparative | Comparative |
|---|---|---|---|---|---|
| | | Example 1 | Example 2 | Example 1 | Example 2 |
| Contact | Initial | 0.30 | 0.28 | 0.29 | 0.28 |
| resistance | Reli- | 0.41 | 0.43 | 0.51 | 0.57 |
| (Ω) | ability | | | | |

| | | | | |
|---|---|---|---|---|
| Preliminary tack | 9 | 10 | 3 | 5 |

As shown in Table 3, the anisotropic conductive films according to Examples 1 and 2 exhibited high reliability of contact resistance and particularly exhibited considerably improved preliminary tack. In contrast, the anisotropic conductive films according to Comparative Examples 1 and 2, where the first insulating adhesive layer and the second insulating adhesive layer were disposed in an opposite way, exhibited inferior reliability and exhibited remarkably low preliminary tack.

By way of summation and review, with recent growth and advances of the liquid crystal display industry, it is desirable for anisotropic conductive films to have processability for continuous production of modules and high circuit connection performance. Thus, it is desirable for the anisotropic conductive films to have good adhesion to diverse circuit members, high reliability for fine circuits, and suitability for subsequent processes.

Anisotropic conductive films having a monolayer or bilayer structure may have limitations in fulfilling the above requirements. Thus, anisotropic conductive films having a trilayer structure are desirable to meet their inherent roles and suitability for subsequent processing. Furthermore, it is desirable to control the melt viscosities of constituent layers of the anisotropic conductive films to achieve suitability for pressurization processes.

Although conventional anisotropic conductive films having a trilayer structure can ensure both insulation performance between adjacent circuit terminals and conductivity between connection circuit terminals, such conventional anisotropic conductive films may be unsatisfactory in terms of suitability for pressurization processes.

Accordingly, it is desirable to provide an anisotropic conductive film having improved preliminary tack, and an apparatus including the same.

Embodiments provide an anisotropic conductive film including a first insulating adhesive layer, a conductive adhesive layer, and a second insulating adhesive layer, which are sequentially deposited on a base film, wherein an adhesive strength ratio of the second insulating adhesive layer to the first insulating adhesive layer is about 1.1 to about 20, for example, about 1.3 to about 5. Embodiments also provide an apparatus including the anisotropic conductive film. The anisotropic conductive film according to embodiments may have improved preliminary tack and an apparatus including the anisotropic conductive film.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. An anisotropic conductive film, comprising a first insulating adhesive layer, a conductive adhesive layer, and a second insulating adhesive layer which are sequentially stacked on a base film, wherein an adhesive strength ratio of the second insulating adhesive layer to the first insulating adhesive layer is about 1.1 to about 20.

2. The anisotropic conductive film as claimed in claim 1, wherein the adhesive strength ratio of the second insulating adhesive layer to the first insulating adhesive layer is about 1.3 to about 5.

3. The anisotropic conductive film as claimed in claim 1, wherein:
the first insulating adhesive layer has an adhesive strength of about 10 to about 100 gf, and
the second insulating adhesive layer has an adhesive strength of about 50 to about 150 gf.

4. The anisotropic conductive film as claimed in claim 1, wherein:
the first insulating adhesive layer has an adhesive strength of about 20 to about 60 gf, and
the second insulating adhesive layer has an adhesive strength of about 50 to about 90 gf.

5. The anisotropic conductive film as claimed in claim 1, wherein a melt viscosity ratio of the second insulating adhesive layer to the first insulating adhesive layer at 40° C. is about 0.01 to about 1.0.

6. The anisotropic conductive film as claimed in claim 1, wherein:
the first insulating adhesive layer has a melt viscosity of about 1.0×10⁵ to about 5.0×10⁵ Pa·s, and
the second insulating adhesive layer has a melt viscosity of about 1.0×10⁴ to about 1.5×10⁵ Pa·s.

7. The anisotropic conductive film as claimed in claim 1, wherein:
a thickness ratio of the first insulating adhesive layer to the conductive adhesive layer is about 1.1 to about 7.5, and
a thickness ratio of the conductive adhesive layer to the second insulating adhesive layer is about 1.3 to about 150.

8. The anisotropic conductive film as claimed in claim 1, wherein the first insulating adhesive layer includes a binder part, a curing part, and a radical initiator, the binder part including a polyurethane acrylate resin, and the curing part including an epoxy (meth)acrylate oligomer and a (meth)acrylate monomer.

9. The anisotropic conductive film as claimed in claim 8, wherein the first insulating adhesive layer includes about 55 to about 80 wt % of the binder part, about 9 to about 40 wt % of the curing part, and about 1 to about 5 wt % of the radical initiator, based on solid content.

10. The anisotropic conductive film as claimed in claim 1, wherein the conductive adhesive layer includes a binder part, a curing part, a radical initiator, and conductive particles, the binder part including an acrylonitrile thermoplastic resin, a polyurethane acrylate resin and a phenoxy thermoplastic resin, the curing part including an epoxy (meth)acrylate oligomer and a (meth)acrylate monomer.

11. The anisotropic conductive film as claimed in claim 10, wherein the conductive adhesive layer includes about 35 to about 68 wt % of the binder part, about 30 to about 50 wt % of the curing part, about 1 to about 5 wt % of the radical initiator, and about 1 to about 10 wt % of the conductive particles, based on solid content.

12. The anisotropic conductive film as claimed in claim 1, wherein the second insulating adhesive layer includes a binder part, a curing part, and a radical initiator, the binder part including a polyurethane acrylate resin, the curing part including an epoxy (meth)acrylate oligomer and a (meth)acrylate monomer.

13. The anisotropic conductive film as claimed in claim 12, wherein the second insulating adhesive layer includes about 55 to about 80 wt % of the binder part, about 9 to about 40 wt % of the curing part, and about 1 to about 5 wt % of the radical initiator, based on solid content.

14. An apparatus comprising the anisotropic conductive film as claimed in claim 1.

15. The apparatus as claimed in claim 14, wherein the adhesive strength ratio of the second insulating adhesive layer to the first insulating adhesive layer is about 1.3 to about 5.

16. The apparatus as claimed in claim 14, wherein:
the first insulating adhesive layer has an adhesive strength of about 10 to about 100 gf, and
the second insulating adhesive layer has an adhesive strength of about 50 to about 150 gf.

17. The apparatus as claimed in claim 14, wherein the first insulating adhesive layer includes about 55 to about 80 wt % of the binder part, about 9 to about 40 wt % of the curing part, and about 1 to about 5 wt % of the radical initiator, based on solid content.

18. The apparatus as claimed in claim 14, wherein the conductive adhesive layer includes about 35 to about 68 wt % of the binder part, about 30 to about 50 wt % of the curing part, about 1 to about 5 wt % of the radical initiator, and about 1 to about 10 wt % of the conductive particles, based on solid content.

19. The apparatus as claimed in claim 14, wherein the second insulating adhesive layer includes about 55 to about 80 wt % of the binder part, about 9 to about 40 wt % of the curing part, and about 1 to about 5 wt % of the radical initiator, based on solid content.
